(19) United States
(12) Patent Application Publication
(10) Pub. No.: US 2013/0262433 A1
(43) Pub. Date: Oct. 3, 2013

(54) Filtering a Distributed Join

(71) Applicants: James Qiu, Santa Clara, CA (US); Murali Vemulapati, Santa Clara, CA (US)

(72) Inventors: James Qiu, Santa Clara, CA (US); Murali Vemulapati, Santa Clara, CA (US)

(21) Appl. No.: 13/437,464

(22) Filed: Apr. 2, 2012

(51) Int. Cl. G06F 17/30

(52) U.S. Cl. 707/714; 707/E17.054

(57) ABSTRACT

Methods, program products, and systems for filtering a distributed join are described. A computing device can receive a database join request to join a first table stored on a first system and a second table stored on a second system to create a related data set. The join request can include a filtering condition for filtering the related data set. The system can divide the filtering condition into a first sub-condition and a second sub-condition, and send the first sub-condition and a second sub-condition to the first system and second system, respectively. The first system and second system can then perform filtering locally, and send filtered intermediate result to the computing device.

### TECHNICAL FIELD

This disclosure relates generally to database management systems.

### BACKGROUND

In a relational database, data can be stored in tables each having one or more rows of data records. A join operation can be used to combine records from two or more tables in a database. A join can create a data set based on the combined records. If two tables each has M rows of data records and N rows of data records, respectively, the data set produced by the join can include a maximum M×N rows of combined records. Sometimes, a join is associated with one or more filtering conditions. The filtering condition can be expressed as a calculation formula that returns a Boolean value. When filtering conditions exist, the total number of rows in the data set produced by the join can be reduced by filtering.

### SUMMARY

Methods, program products, and systems for filtering a distributed join are described. A computing device can receive a database join request to join a first table stored on a first system and a second table stored on a second system to create a related data set. The join request can include a filtering condition for filtering the related data set. The system can divide the filtering condition into a first sub-condition and a second sub-condition, and send the first sub-condition and a second sub-condition to the first system and second system, respectively. The first system and second system can then perform filtering locally, and send filtered intermediate result to the computing device. The computing can perform a join using the filtered intermediate result to generate a final result set.

Filtering distributed join can be implemented to achieve the following advantages over a conventional database system. The data are filtered remotely in a distributed manner. Accordingly, filtering can be performed at a most efficient host, for example, a host that has an index most suitable for the filtering. Data transmission between hosts can involve filtered data, which can result in reduced network bandwidth usage. A join using the filtered data can be smaller than a conventional join using unfiltered data, thereby enhancing performance.

The details of one or more implementations of filtering a distributed join are set forth in the accompanying drawings and the description below. Other features, aspects, and advantages of filtering a distributed join will become apparent from the description, the drawings, and the claims.

### BRIEF DESCRIPTION OF THE DRAWINGS

FIG. 1 illustrates an exemplary system for filtering a distributed join.

FIG. 2 is a block diagram illustrating filtering a distributed join in an indirect relationship.

FIG. 3 is an exemplary user interface for filtering a distributed join.

FIG. 4A is an exemplary relationship graph.

FIGS. 4B and 4C are exemplary relationship sub-graphs.

FIG. 5 is a block diagram of a partition of an exemplary filter.

FIG. 6 is a flowchart illustrating an exemplary process of distributed join.

FIG. 7 is a block diagram of an exemplary system architecture for implementing the features and operations of FIGS. 1-6.

Like reference symbols in the various drawings indicate like elements.

### DETAILED DESCRIPTION

### Overview

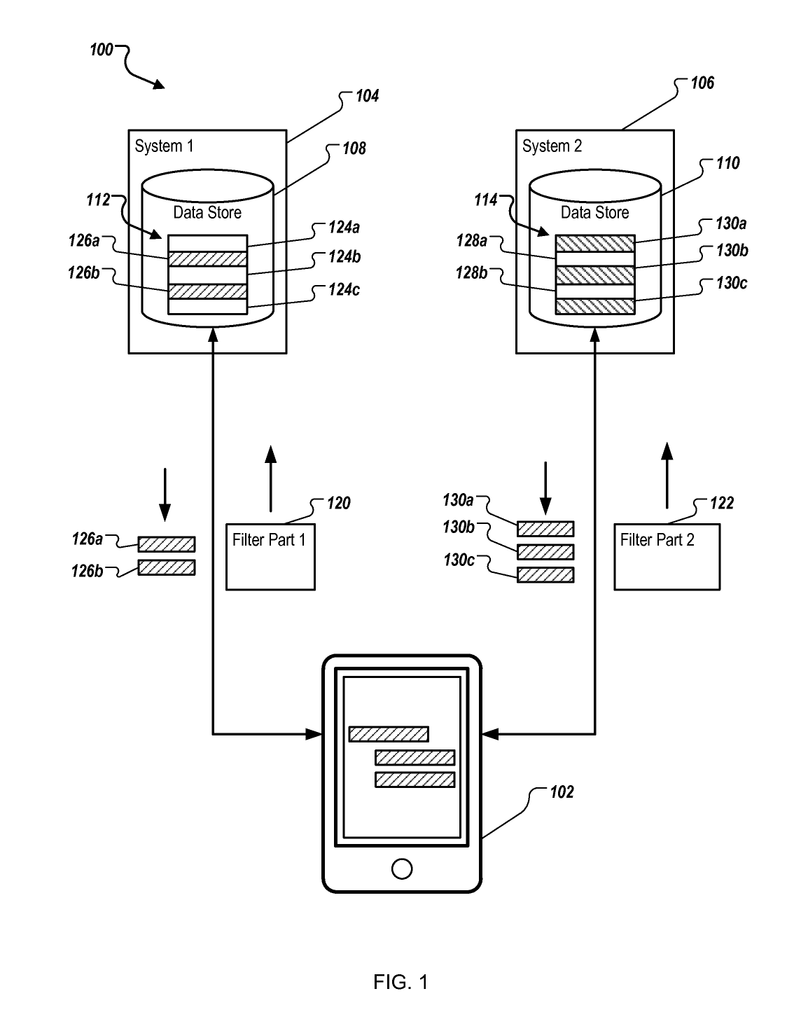

FIG. 1 illustrates exemplary system 100 for filtering a distributed join. System 100 can include computing device 102, remote system 104, and remote system 106. Computing device 102 can be a user device or a server device. Each of remote system 104 and remote system 106 can host a respective database, e.g., database 108 and database 110, respectively. Database 108 and database 110 can be relational databases. Database 108 and database 110 each can include a data table, e.g., table 112 and table 114, respectively.

Computing device 102 can be connected to remote system 104 and remote system 106 through a communications network. Computing device 102 can host a database application program that is configured to retrieve data stored in a database, and to format the retrieved data to generate a report according to a layout. Computing device 102 can determine that to generate the report, computing device shall execute a query. The query can include a join of table 112 and table 114, and a filter of the join.

In a conventional relational database management system (RDBMS), a query can be optimized based on resource footprints of various query plans. The resource footprint can include, for example, number of processors, amount of buffer, or interconnect usage between units of parallelism. In system 100, table 112 and table 114 are hosted remotely from computing device 102. Computing device 102 may not have all the information for performing query optimization. In addition, the query at computing device 102 may change frequently and rapidly due to user input. The rapid change in queries may require frequent query optimizations that may appear to increase, rather than decrease, response time.

Computing device 102 can, however, attempt to optimize execution of the query by delegating query optimization tasks to remote systems 104 and 106. Computing device 102 can delegate the query optimization tasks by analyzing the query and analyzing information on the tables referred to in the query.

For example, the layout based on which computing device 102 formats the report can include a portal object. The portal object can be a component of the layout that can be used to display related records. Often, the set of related records may include too many rows for display. Computing device 102 can implement a portal filter for dynamically filtering the set of related records such that a smaller set of related record is displayed.

For illustrative purposes, table 112 can be a table named CUSTOMER; table 114 can be a table named ORDERS. Table 112 can be keyed on a field CustomerId, which can be a foreign key in table 114. Table 114 can include an “order_status” field having a Boolean value “open” or “closed.” Computing device 102 can have a portal that relates table 112 to table 114 based on CustomerId. A relationship between table 112 and table 114 can be specified in a matching condition as follows.

CUSTOMERS.CustomerId=ORDERS.CustomerID (1)

A cross product of customers and orders can yield a large set of record the size of which a user may wish to reduce. Computing device 102 can provide for display one or more additional controls for limiting the number of records in the set. For example, computing device 102 can provide for display a checkbox for specifying a status of an order, such that, when the checkbox is checked, only open orders are displayed; when the checkbox is unchecked, only closed orders are displayed. An exemplary filter on order status is shown in the following calculation expression.

If(ORDERS::order_status=‘open’;1;0) (2)

There can be multiple user interface items. Any change of user input in the multiple user interface items can result in a different query. A conventional RDBMS will perform a separate query optimization on each variation of the queries.

Computing device 102 can divide each variation of a query into multiple components. When a portal filter includes a filtering condition, e.g., for filtering results, computing device 102 can determine which part of the condition is sent to which remote system. For example, computing device 102 can determine that the query includes a portal filter that is configured to filter a result set based on a customer states, e.g., whether a customer is a trusted customer or a regular customer. The portal filter can additionally be configured to filter a result set based on an order status, e.g., whether an order of the customer is open or closed. Computing device 102 can divide the portal filter to first sub-condition 120 and second sub-condition 122. First sub-condition 120 can include a portion of the portal filter that specifies the customer status. Second sub-condition 122 can include a portion of the portal filter that specifies the order status.

Computing device 102 can determine that first sub-condition 120 is related to a field in table 112 that is stored in database 108, and that second sub-condition 120 is related to a field in table 114 that is stored in database 110. Computing device 102 can make the determination based on table names or field names or both as specified in the portal filter. For example, computing can determine second sub-condition “ORDERS.order_status=open” based on the table name “ORDERS” or the field name “order_status” as specified in the portal filter.

Upon receiving the sub-conditions, each of database 108 and database 110 can make filter data records with the respective sub-condition. For example, database 108 can determine, based on first sub-condition 120, that among data records 124a, 124b, 124c, 126a, and 126b, data records 126a and 126b satisfy first sub-condition 120. Accordingly, database 108 can send data records 126a and 126b or identifiers of data records 126a and 126b to computing device 102. Likewise, database 110 can determine, based on second sub-condition 122, that among data records 128a, 128b, 130a, 130b, and 130c, data records 130a, 130b, and 130c satisfy second sub-condition 122.

Upon receiving the data records computing device 102 can perform a join operation to determine which of the received data records can be provided in the portal for display. The join can be performed based on the filtered set of data records rather than complete set of data records.

### Indirect Relationship

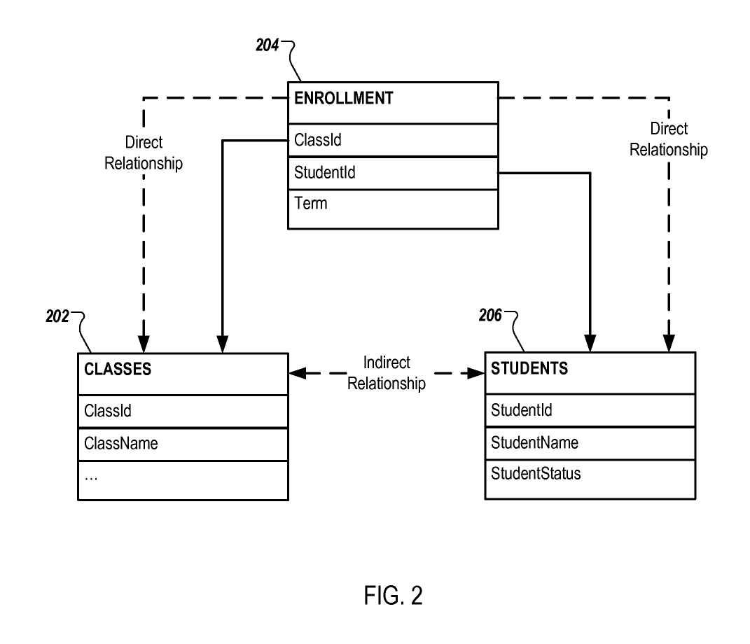

FIG. 2 is a block diagram illustrating filtering a distributed join in an indirect relationship. Tables can relate to one another in a direct relationship or an indirect relationship. Two tables can be directly related if there is a relationship defined between them using a set of one or more join predicates. For example, exemplary table 112 and exemplary table 114 of FIG. 1 can be directly related.

The operations of filtering a distributed join can be performed when there is an indirect relationship. Two tables can be indirectly related to one another if there is no direct relation between the two tables, but the two tables are related through one or more intermediate tables. A portal in a layout can display records from a table (portal table) even if the table is only indirectly related to another table of the layout (layout table). A system implementing the filtering techniques can compute intermediate joins for displaying the records in the portal. A portal filter condition (e.g., an expression) can contain sub-conditions involving fields from any of the intermediate tables. The system can partition the filter condition into sub-conditions such that each sub-condition can be a filter on a corresponding join operation.

For illustration, the system can include table 202 “CLASSES,” table 204 “ENROLLMENT,” and table 206 “STUDENTS.” Table 202 can have fields “ClassId” and “ClassName.” Table 204 can have fields “ClassId,” “StudentId,” and “ClassName.” Table 206 can have fields “StudentId,” “StudentName,” and “StudentStatus.” The “StudentStatus” field can specify whether a student is a full time or part time student. Tables 202 and 204 can be related by a join predicate that reads as follows.

CLASSES.ClassId=ENROLLMENT.ClassId (3)

Tables 204 and 206 can be related by a join predicate that reads as follows.

ENROLLMENT.StudentId=STUDENTS.StudentId (4)

In this example, table 202 “CLASSES” and table 206 “STUDENTS” are indirectly related to one another. If a computing device (e.g., computing device 102 of FIG. 1) generates a report using a layout for table 202 “CLASSES,” and that the layout includes a portal for table 206 “STUDENTS.” The portal can be configured to display students enrolled in a given class. The computing device can include a portal filter configured to filter the students by a condition. An exemplary portal filter can read as follows.

| STUDENTS.StudentStatus = ’Full Time’ AND | |
|---|---|
| ENROLMENT.Term = ’Fall’ | (5) |

The portal filter can cause only full time students in a fall term of a particular class be displayed. In some implementations, the join between table 202 “CLASSES” and table 206 “STUDENTS” can be computed as follows.

Join(Join(CLASSES, ENROLLMENT),STUDENTS) (6)

A final result set is then filtered using the portal filter as follows.

Filter(Join(Join(CLASSES,ENROLLMENT),STUDENTS)), (7)

where “Filter” is the portal filter. In some implementations, the portal filter can be divided into multiple parts and moved into the join computation. For example, a final result set can be computed as follows.

| Join(Join(CLASSES, ENROLLMENT, Filter_1), | |
|---|---|
| STUDENTS, Filter_2), | (8) |

where Filter_{—}1 can include a first portion of the portal filter, e.g., “ENROLMENT.Term=‘Fall’”; Filter_{—}2 can include a second portion of the portal filter, e.g., “STUDENTS.StudentStatus=‘Full Time’.”

### User Interfaces

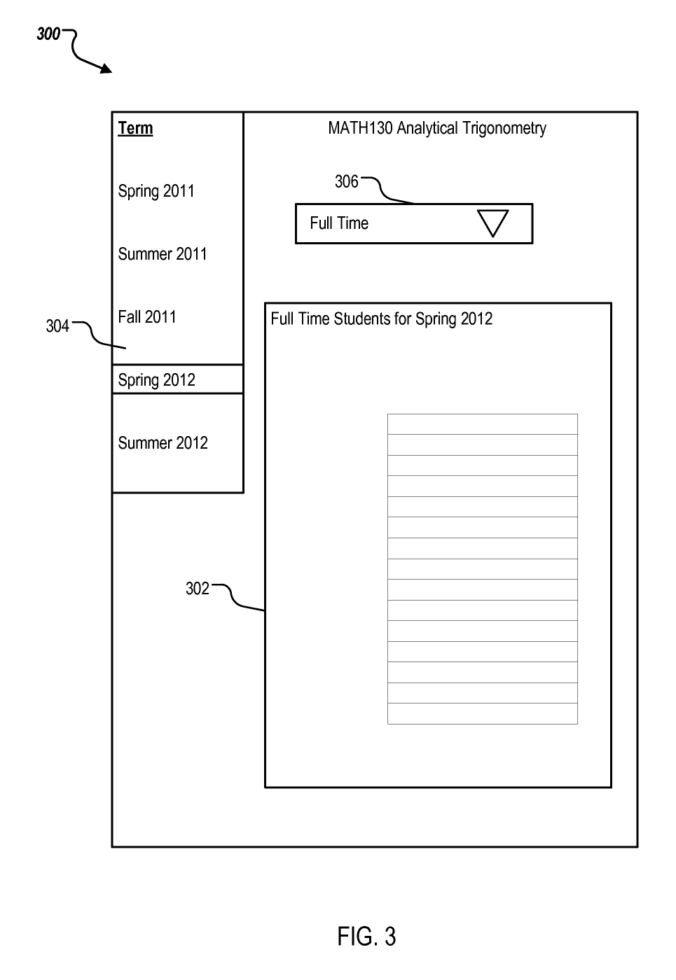

FIG. 3 is exemplary user interface 300 for filtering a distributed join. User interface 300 can be a report formatted based on a layout of a base table, e.g., table 202 “CLASSES” of FIG. 2. The report can be a form-like view of a particular record in table 202 “CLASSES,” e.g., a record having ClassId “MATH130” and ClassName “Analytical Trigonometry.”

User interface 300 can include portal 302. Portal 302 can include a table-like view of one or more records of students, for example, as stored in table 206 “STUDENTS” of FIG. 2. The data in portal 302 can be from a table that is indirectly related to the base table. The table for data in portal 302 and the base table can be stored in different databases hosted on systems remote from one another. The table for data in portal 302 and the base table can be related through the layout at design time.

User interface 300 can include filter configuration items 304 and 306. Filter configuration items 304 and 306 can be used to configure a portal filter for portal 302. Filter configuration items 304 and 306 can be placed in the layout at design time. In the example shown, filter configuration item 304 can be used to specify a first sub-condition of a condition of the portal filter (e.g., a sub-condition based on ENROLLMENT.Term data field). Filter configuration item 306 can be used to specify a second sub-condition of a condition of the portal filter (e.g., a sub-condition based on STUDENTS.StudentStatus data field).

### Relationship Graphs

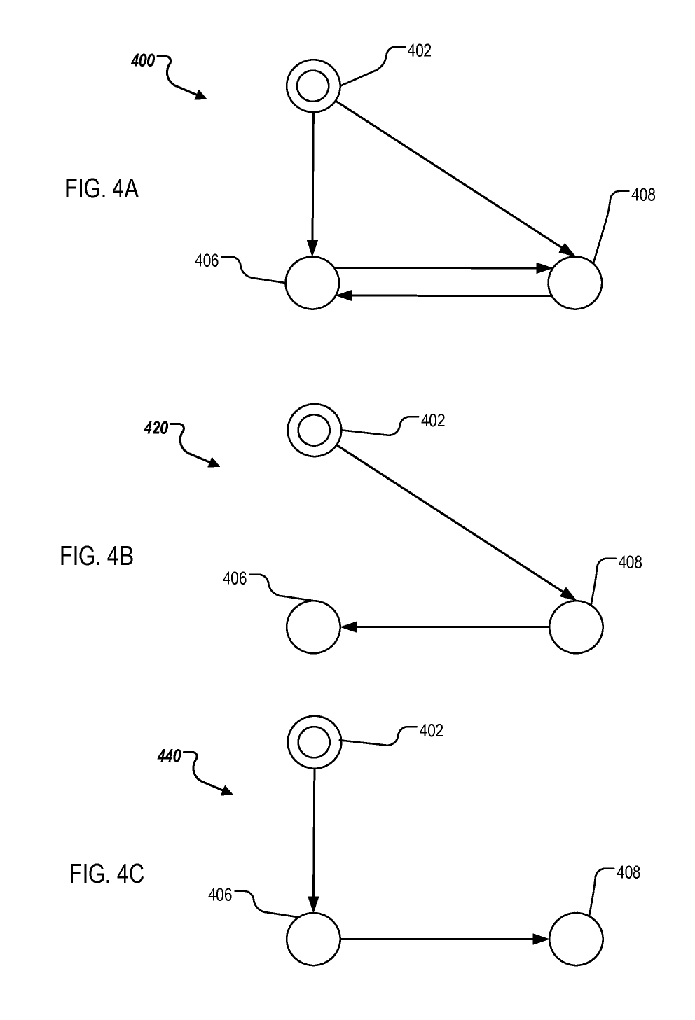

FIG. 4A is an exemplary relationship graph 400. When a computing device divides a condition in a portal filter into multiple sub-conditions, there can be multiple ways to divide the condition. The computing device can identify an optimal division based on a cost of each way to divide the condition. The computing device can calculate the cost based on exemplary relationship graph 400.

Relationship graph 400 can include one or more nodes. Each node can represent a database table. For example, node 402 can represent a base table Tb. Nodes 406 and 408 can represent tables T1 and T2 that store data for display in a portal. Each edge can represent a direct relationship between two tables. The edges can be directional, where the direction of an edge can represent a direction of a relationship. For example, a direct edge between node 402 and node 406 can indicate that the base table, as represented by node 402, stores a foreign key to the table represented by node 406. For illustration, the portal is configured to display data retrieved using the following structured query language (SQL) statement.

| SELECT Tb.columnA, T1.columnB, T2.columnC | |
|---|---|
| WHERE [predicates for joining Tb, T1, and T2 ] AND | |
| Tb.a >= x; AND | |
| T1.b<=y; AND | |
| T2.c <> z; | (10) |

where the section “Tb.a>=x; AND T1.b<=y; AND T2.c< >z;” is an exemplary portal filter. The system can identify one or more paths in relationship graph 400, each path corresponding to a cost, and divide the portal filter according to a path that corresponds to the optimal cost. The cost can be a value determined based on where a join is computed, a transaction cost, or whether a table is indexed. In some implementations, the higher the degree of distribution a join is performed on multiple systems, the lower the cost; the less the data being sent through a network, the lower the cost; a join of indexed tables has a lower cost than a join of tables not indexed.

FIGS. 4B and 4C are exemplary relationship sub-graphs. FIG. 4B is exemplary sub-graph 420 of relationship group 400 of FIG. 4A. The path starts from node 402, reaches node 408, and ends at node 406. The path shown in FIG. 4B can correspond to a way of dividing the join and the portal filter such that table Tb is first joined with table T2 and filtered using a portion of the portal filter “Tb.a>=x; AND T2.c< >z.” The result is then joined with table T1 and filtered using a portion of the portal filter “T1.b<=y.” A first cost for computing the join and performing the filtering can be determined.

FIG. 4C is exemplary sub-graph 440 of relationship group 400 of FIG. 4A. The path starts from node 402, reaches node 406, and ends at node 408. The path shown in FIG. 4B can correspond to a way of dividing the join and the portal filter such that table Tb is first joined with table T1 and filtered using a portion of the portal filter “Tb.a>=x; AND T1.b<=y.” The result is then joined with table T2 and filtered using a portion of the portal filter “T2.c< >z.” A second cost for computing the join and performing the filtering can be determined. A computing device can compare the first cost and the second cost and determine whether to divide the condition in the portal filter according to sub-graph 420 or sub-graph 440.

### Partitioning a Filter

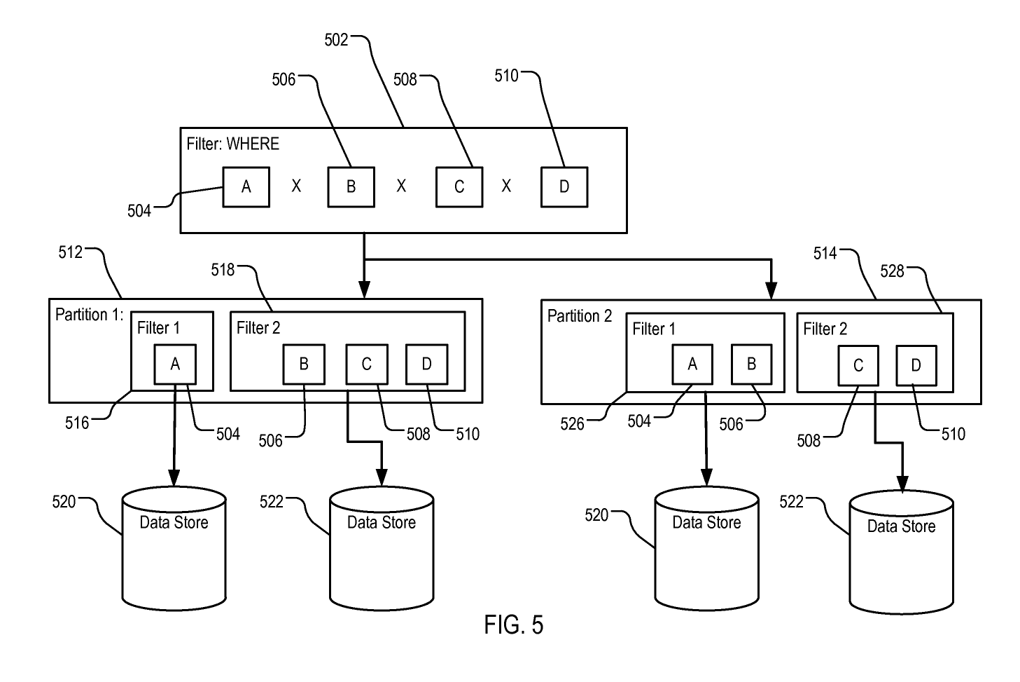

FIG. 5 is a block diagram of a partition of an exemplary filter 502. Filter 502 can be a portal filter as described above in references to FIGS. 1-4. Filter 502 can include a condition in the form of an expression in a WHERE clause of a data query language statement. The expression can include components 504, 506, 508, and 510. Each of components 504, 506, 508, and 510 can include a Boolean expression. Components 504, 506, 508, and 510 can be connected by logical operators including, for example, AND, OR, or NOT.

A computing device can partition filter 502 according to partition 512 or partition 514. Partition 512 and partition 514 can each correspond to a distinct path in a relationship graph as described in reference to FIGS. 4A-4C. According to partition 512, the computing device can divide filter 502 into first sub-condition 516 and second sub-condition 518. First sub-condition 516 can include expression component 504. Second sub-condition 518 can include expression components 506, 508, and 510. If the computing device partitions filter 502 according to partition 512, the computing device can send first sub-condition 516 to first database 520, and second sub-condition 518 to second database 522.

According to partition 514, the computing device can divide filter 502 into first sub-condition 526 and second sub-condition 528. First sub-condition 526 can include expression components 504 and 506. Second sub-condition 528 can include expression components 508, and 510. If the computing device partitions filter 502 according to partition 514, the computing device can send first sub-condition 526 to first database 520, and second sub-condition 528 to second database 522.

The computing device can choose whether to use partition 512 or partition 514 based on a cost associated with each of partition 512 and partition 514. Upon receiving the corresponding sub-conditions, each of database 520 and database 522 can compute joins using the sub-conditions. Each of database 520 and database 522 can perform query optimization, including selecting an optimal query plan.

### Exemplary Distributed Join Processes

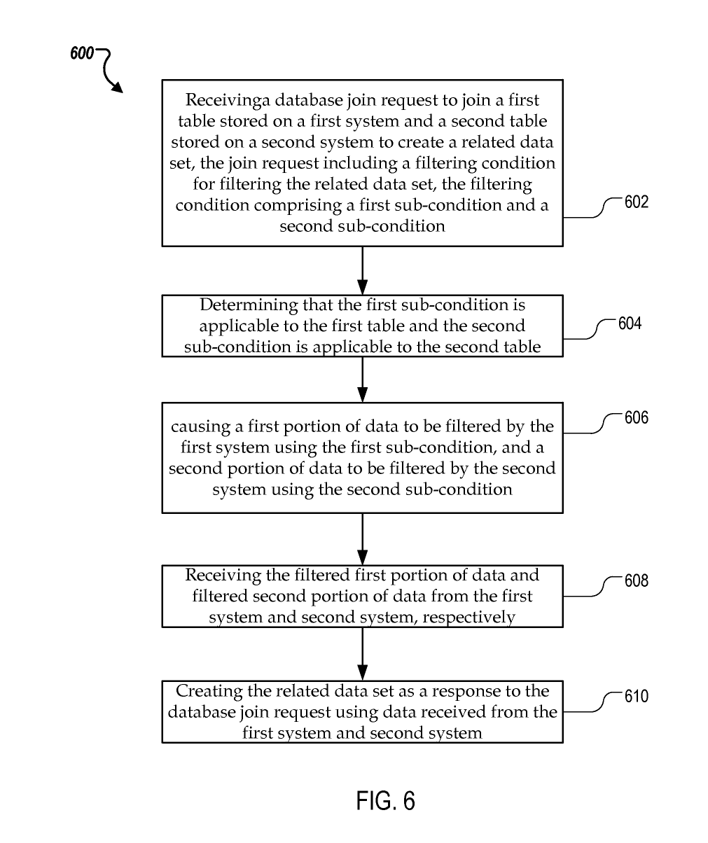

FIG. 6 is a flowchart illustrating an exemplary process 600 of distributed join. A computing device can receive (602) a database join request to join a first table stored on a first system and a second table stored on a second system to create a related data set. The first system and second system can be located remotely from one another. At least one of the first system and second system can be located remotely from the mobile device. The join request can include a filtering condition for filtering the related data set. The filtering condition can be a portal filter specified as one or more expressions in a in a data query statement, for example, in a WHERE clause of a SQL statement. The filtering condition can include a first sub-condition and a second sub-condition. Each of the first sub-condition and second sub-condition can include at least one of the expressions.

In some implementations, receiving the database join request can include receiving an input from a view formatted according to a layout. The layout can specify a base table and a portal for displaying data related to a record of the base table. The input can include one or more data specifications, e.g., filtering conditions for filtering data before the data are displayed in the portal. The mobile device can generate, based on the one or more data specifications, the filtering condition. The computing device can divide the filtering condition into the first sub-condition and second sub-condition before or without performing query optimization operations.

In some implementations, dividing the filtering condition into the first sub-condition and the second sub-condition can include performing the following operations by the computing device. The computing device can generate, based on the filtering condition and the base table, multiple division plans. Each division plan can specify a distinct manner of dividing the filtering condition. The computing device can estimate a cost for each division plan. The computing device can then divide the filtering condition into the first sub-condition and the second sub-condition according to a division plan in a group of division plans that includes a division plan that is associated with a lowest cost. The computing device can determine, based on the estimated cost, that the first portion of data is to be filtered by the first system and that the second portion of data is to be filtered by the second system.

In some implementations, the estimated cost can include at least one of a projected processing time or a projected network load. Estimating the cost can be based at least in part on one of the following:

A. whether a portion of the data is stored locally at the computing device;

B. a data transport delay for transporting a portion of the data from a remote system to the computing device; or

C. whether at least a portion of data is indexed on a remote server.

In some implementations, estimating the cost can include performing the following operations by the computing device. The computing device can provide a sub-condition to a remote system for evaluation. The computing device can receive a metric from the remote system. The metric can include at least one of the following:

A. an indicator of a result set size;

B. an indicator of processing time if the sub-condition is applied at the remote system; or

C. an indicator of whether at least a portion of data is indexed on a remote server.

The computing device can estimate the cost based on the received metric.

In some implementations, generating the division plans can include performing the following operations by the computing device. The computing device can identify multiple manners of dividing the filtering condition based on the base table and a relationship graph. Each manner of dividing the filtering condition can correspond to a distinct path in the relationship graph. The relation graph can be a data structure having multiple nodes and one or more directed edges. Each directed edge can connect a first node representing a first table and second node representing a second table. A direction of the directed edge can indicate a dependency relationship between the first table and the second table regardless of whether the first or second table contains a key to one another. An example of a relationship graph is shown above in FIG. 4A. The computing device can generate a division plan for each identified manner

The computing device can determine (604) that the first sub-condition is applicable to the first table and the second sub-condition is applicable to the second table.

The computing device can cause (606) a first portion of data to be filtered by the first system using the first sub-condition, and a second portion of data to be filtered by the second system using the second sub-condition. Causing a portion of data to be filtered at a system can include sending a join request and a sub-condition to the system.

The computing device can receive (608) the filtered first portion of data and filtered second portion of data from the first system and second system, respectively.

The computing device can create (610) the related data set as a response to the database join request using data received from the first system and second system. The computing device can provide at least a portion of the related data set for display in the view on a display device, wherein the view includes a table view, a form view, or a list view. For example, the computing device can provide the related data set for display in a portal, and refresh the displayed related data set when the filtering condition changes.

### Exemplary System Architecture

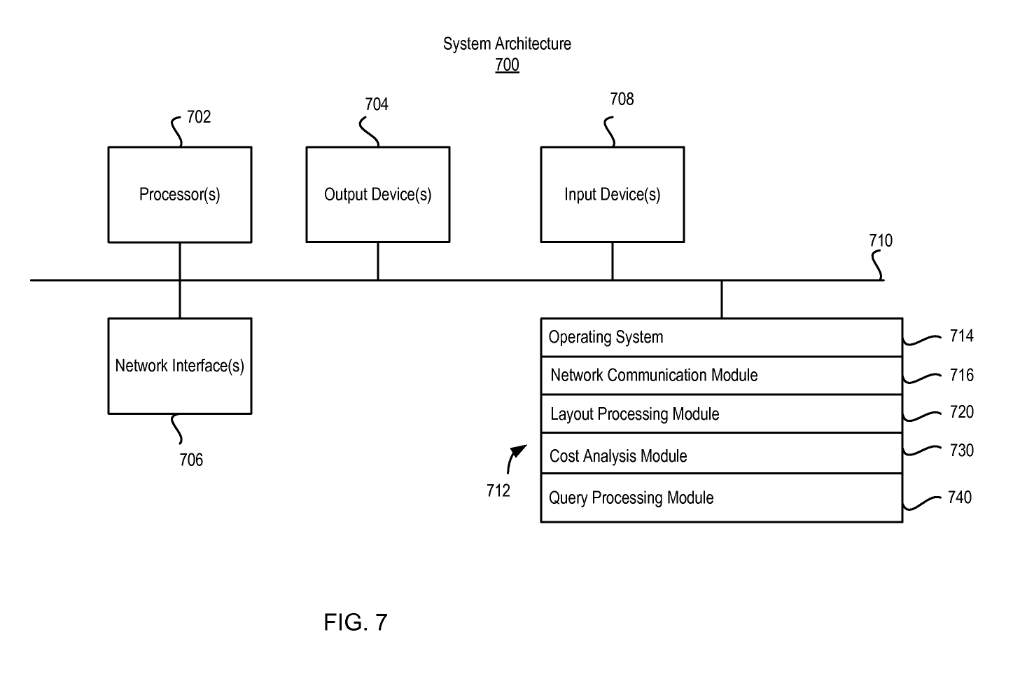

FIG. 7 is a block diagram of an exemplary system architecture 700 for implementing the features and operations of FIGS. 1-6. Other architectures are possible, including architectures with more or fewer components. In some implementations, architecture 700 includes one or more processors 702 (e.g., dual-core Intel® Xeon® Processors), one or more output devices 704 (e.g., LCD), one or more network interfaces 706, one or more input devices 708 (e.g., mouse, keyboard, touch-sensitive display) and one or more computer-readable mediums 712 (e.g., RAM, ROM, SDRAM, hard disk, optical disk, flash memory, etc.). These components can exchange communications and data over one or more communication channels 710 (e.g., buses), which can utilize various hardware and software for facilitating the transfer of data and control signals between components.

The term “computer-readable medium” refers to a medium that participates in providing instructions to processor 702 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 712 can further include operating system 714 (e.g., a Linux® operating system), network communication module 716, layout processing module 720, cost analysis module 730, and query processing module 740. Operating system 714 can be multi-user, multiprocessing, multitasking, multithreading, real time, etc. Operating system 714 performs basic tasks, including but not limited to: recognizing input from and providing output to devices 706, 708; keeping track and managing files and directories on computer-readable mediums 712 (e.g., memory or a storage device); controlling peripheral devices; and managing traffic on the one or more communication channels 710. Network communications module 716 includes various components for establishing and maintaining network connections (e.g., software for implementing communication protocols, such as TCP/IP, HTTP, etc.).

Layout processing module 720 can include computer instructions that, when executed, cause processor 702 to format data for output according to a layout, generate expressions in filtering conditions from user input, and define relationships in a relationship graph. Cost analysis module 730 can include computer instructions that, when executed, cause processor 702 to obtain performance information from local and remote sources, identify distinct paths from a relationship graph, calculate a cost for each path, and determine an optimal path based on the costs. Query processing module 740 can include computer instructions that, when executed, cause processor 702 to divide a filtering condition to multiple sub-conditions, divide a join to multiple distributed joins, and send at least one of the sub-condition and a corresponding join to a remote system for processing.

Architecture 700 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

What is claimed is:

1. A method comprising:
receiving, by a computing device, a database join request to join a first table stored on a first system and a second table stored on a second system to create a related data set, the database join request including a filtering condition for filtering the related data set, the filtering condition comprising a first sub-condition and a second sub-condition;
determining that the first sub-condition is applicable to the first table and the second sub-condition is applicable to the second table;
causing a first portion of data to be filtered by the first system using the first sub-condition, and a second portion of data to be filtered by the second system using the second sub-condition;
receiving the filtered first portion of data and filtered second portion of data from the first system and second system, respectively; and
creating, by the computing device, the related data set as a response to the database join request using data received from the first system and second system.

2. The method of claim 1, wherein receiving the database join request comprises:
receiving an input from a view formatted according to a layout, the input comprising one or more data specifications, the layout specifying a base table; and
generating, based on the one or more data specifications, the filtering condition, the filtering condition including a plurality of expressions in a data query statement.

3. The method of claim 2, wherein: each of the first sub-condition and second sub-condition comprises at least one of the plurality of expressions.

4. The method of claim 3, comprising:
dividing the filtering condition into the first sub-condition and second sub-condition before or without performing query optimization operations.

5. The method of claim 4, wherein dividing the filtering condition into the first sub-condition and the second sub-condition comprises:
generating, based on the filtering condition and the base table, a plurality of division plans, each division plan specifying a distinct manner of dividing the filtering condition;
estimating a cost for each division plan; and
dividing the filtering condition into the first sub-condition and the second sub-condition according to a division plan in a group of division plans that includes a division plan that is associated with a lowest cost.

6. The method of claim 5, wherein generating the division plans comprises:
identifying a plurality of manners of dividing the filtering condition based on the base table and a relationship graph, each manner of dividing the filtering condition corresponding to a distinct path in the relation graph; and
generating a division plan for each identified manner.

7. The method of claim 6, wherein the relation graph is a data structure comprising a plurality of nodes and one or more directed edges, each directed edge connecting a first node representing a first table and second node representing a second table, wherein a direction of the directed edge indicates a dependency relationship between the first table and the second table regardless of whether the first or second table contains a key to one another.

8. The method of claim 5, comprising determining, based on the estimated cost, that the first portion of data is to be filtered by the first system and that the second portion of data is to be filtered by the second system.

9. The method of claim 5, wherein:
the estimated cost comprises at least one of a projected processing time or a projected network load, and
estimating the cost is based at least in part on one of:
whether a portion of the data is stored locally at the computing device;
a data transport delay for transporting a portion of the data from a remote system to the computing device; or
whether at least a portion of data is indexed on a remote server.

10. The method of claim 9, wherein estimating the cost comprises:
providing, by the computing device, a sub-condition to a remote system for evaluation;
receiving a metric from the remote system, the metric includes at least one of:
an indicator of a result set size;
an indicator of processing time if the sub-condition is applied at the remote system; or
an indicator of whether at least a portion of data is indexed on a remote server; and
estimating the cost based on the received metric.

11. The method of claim 2, comprising providing at least a portion of the related data set for display in the view on a display device, wherein the view includes a table view, a form view, or a list view.

12. A system comprising:
one or more processors configured to perform operations comprising:
receiving, by a computing device, a database join request to join a first table stored on a first system and a second table stored on a second system to create a related data set, the database join request including a filtering condition for filtering the related data set, the filtering condition comprising a first sub-condition and a second sub-condition;
determining that the first sub-condition is applicable to the first table and the second sub-condition is applicable to the second table;
causing a first portion of data to be filtered by the first system using the first sub-condition, and a second portion of data to be filtered by the second system using the second sub-condition;
receiving the filtered first portion of data and filtered second portion of data from the first system and second system, respectively; and
creating, by the computing device, the related data set as a response to the database join request using data received from the first system and second system.

13. The system of claim 12, wherein receiving the database join request comprises:
receiving an input from a view formatted according to a layout, the input comprising one or more data specifications, the layout specifying a base table; and
generating, based on the one or more data specifications, the filtering condition, the filtering condition including a plurality of expressions in a data query statement.

14. The system of claim 13, wherein: each of the first sub-condition and second sub-condition comprises at least one of the plurality of expressions.

15. The system of claim 14, the operations comprising:
dividing the filtering condition into the first sub-condition and second sub-condition before or without performing query optimization operations.

16. The system of claim 15, wherein dividing the filtering condition into the first sub-condition and the second sub-condition comprises:
generating, based on the filtering condition and the base table, a plurality of division plans, each division plan specifying a distinct manner of dividing the filtering condition;
estimating a cost for each division plan; and
dividing the filtering condition into the first sub-condition and the second sub-condition according to a division plan in a group of division plans that includes a division plan that is associated with a lowest cost.

17. The system of claim 16, wherein generating the division plans comprises:
identifying a plurality of manners of dividing the filtering condition based on the base table and a relationship graph, each manner of dividing the filtering condition corresponding to a distinct path in the relation graph; and
generating a division plan for each identified manner.

18. The system of claim 17, wherein the relation graph is a data structure comprising a plurality of nodes and one or more directed edges, each directed edge connecting a first node representing a first table and second node representing a second table, wherein a direction of the directed edge indicates a dependency relationship between the first table and the second table regardless of whether the first or second table contains a key to one another.

19. The system of claim 16, the operations comprising determining, based on the estimated cost, that the first portion of data is to be filtered by the first system and that the second portion of data is to be filtered by the second system.

20. The system of claim 16, wherein:
the estimated cost comprises at least one of a projected processing time or a projected network load, and
estimating the cost is based at least in part on one of:
whether a portion of the data is stored locally at the computing device;
a data transport delay for transporting a portion of the data from a remote system to the computing device; or
whether at least a portion of data is indexed on a remote server.

21. The system of claim 20, wherein estimating the cost comprises:
providing, by the computing device, a sub-condition to a remote system for evaluation;
receiving a metric from the remote system, the metric includes at least one of:
an indicator of a result set size;
an indicator of processing time if the sub-condition is applied at the remote system; or
an indicator of whether at least a portion of data is indexed on a remote server; and
estimating the cost based on the received metric.

22. The system of claim 13, comprising providing at least a portion of the related data set for display in the view on a display device, wherein the view includes a table view, a form view, or a list view.

23. A computer program product stored on a non-transitory storage device, the product operable to cause one or more processors to perform operations comprising:
receiving, by a computing device, a database join request to join a first table stored on a first system and a second table stored on a second system to create a related data set, the database join request including a filtering condition for filtering the related data set, the filtering condition comprising a first sub-condition and a second sub-condition;
determining that the first sub-condition is applicable to the first table and the second sub-condition is applicable to the second table;
causing a first portion of data to be filtered by the first system using the first sub-condition, and a second portion of data to be filtered by the second system using the second sub-condition;
receiving the filtered first portion of data and filtered second portion of data from the first system and second system, respectively; and
creating, by the computing device, the related data set as a response to the database join request using data received from the first system and second system.

24. The product of claim 23, wherein receiving the database join request comprises:
receiving an input from a view formatted according to a layout, the input comprising one or more data specifications, the layout specifying a base table; and
generating, based on the one or more data specifications, the filtering condition, the filtering condition including a plurality of expressions in a data query statement.

25. The product of claim 24, wherein: each of the first sub-condition and second sub-condition comprises at least one of the plurality of expressions.

26. The product of claim 25, the operations comprising:
dividing the filtering condition into the first sub-condition and second sub-condition before or without performing query optimization operations.

27. The product of claim 26, wherein dividing the filtering condition into the first sub-condition and the second sub-condition comprises:
generating, based on the filtering condition and the base table, a plurality of division plans, each division plan specifying a distinct manner of dividing the filtering condition;
estimating a cost for each division plan; and
dividing the filtering condition into the first sub-condition and the second sub-condition according to a division plan in a group of division plans that includes a division plan that is associated with a lowest cost.

28. The product of claim 27, wherein generating the division plans comprises:
identifying a plurality of manners of dividing the filtering condition based on the base table and a relationship graph, each manner of dividing the filtering condition corresponding to a distinct path in the relation graph; and
generating a division plan for each identified manner.

29. The product of claim 28, wherein the relation graph is a data structure comprising a plurality of nodes and one or more directed edges, each directed edge connecting a first node representing a first table and second node representing a second table, wherein a direction of the directed edge indicates a dependency relationship between the first table and the second table regardless of whether the first or second table contains a key to one another.

30. The product of claim 27, the operations comprising determining, based on the estimated cost, that the first portion of data is to be filtered by the first system and that the second portion of data is to be filtered by the second system.

31. The product of claim 27, wherein:
the estimated cost comprises at least one of a projected processing time or a projected network load, and
estimating the cost is based at least in part on one of:
whether a portion of the data is stored locally at the computing device;
a data transport delay for transporting a portion of the data from a remote system to the computing device; or
whether at least a portion of data is indexed on a remote server.

32. The product of claim 31, wherein estimating the cost comprises:
providing, by the computing device, a sub-condition to a remote system for evaluation;
receiving a metric from the remote system, the metric includes at least one of:
an indicator of a result set size;
an indicator of processing time if the sub-condition is applied at the remote system; or
an indicator of whether at least a portion of data is indexed on a remote server; and
estimating the cost based on the received metric.

33. The product of claim 24, the operations comprising providing at least a portion of the related data set for display in the view on a display device, wherein the view includes a table view, a form view, or a list view.
